(19) United States
(12) Patent Application Publication
(10) Pub. No.: US 2010/0318531 A1
(43) Pub. Date: Dec. 16, 2010

(54) SMOOTHING CLICKTHROUGH DATA FOR WEB SEARCH RANKING

(75) Inventors: Jianfeng Gao, Kirkland, WA (US); Xiao Li, Bellevue, WA (US); Kefeng Deng, Beijing (CN); Wei Yuan, Montreal (CA); Jian-Yun Nie, Montreal (CA)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/481,593

(22) Filed: Jun. 10, 2009

(51) Int. Cl. G06F 17/30; G06F 15/18

(52) U.S. Cl. 707/759; 706/12; 707/769

(57) ABSTRACT

Described is a technology for using clickthrough data (e.g., based on data of a query log) in learning a ranking model that may be used in online ranking of search results. Clickthrough data, which is typically sparse (because many documents are often not clicked or rarely clicked), is processed/smoothed into smoothed clickthrough streams. The processing includes determining similar queries for a document with incomplete (insufficient) clickthrough data to provide expanded clickthrough data for that document, and/or by estimating at least one clickthrough feature for a document when that document has missing (e.g., no) clickthrough data. Similar queries may be determined by random walk clustering and/or session-based query analysis. Features extracted from the clickthrough streams may be used to provide a ranking model which may then be used in online ranking of documents that are located with respect to a query.

### BACKGROUND

In online Web searching by a search engine, Web search results for an issued query are retrieved and ranked by relevance before being returned in response to the query. In general, a ranking model is used in ranking the results, in which the ranking model is a function that maps the feature vectors of a query-document pair to a real-value relevance score. One type of ranking model is learned on labeled training data using human-judged query-document pairs.

A ranking model can be built from various features related to query-document pairs. For example, a web document can be described by multiple text streams, including a content stream comprising the title and body texts in a page, and an anchor stream comprising the anchor texts of a page's incoming links.

Another text stream for a web document is a clickthrough stream, comprising the user queries that (via their results) resulted in clicks on the document. Incorporating features extracted from the clickthrough stream (referred to as clickthrough features) may significantly improve the performance of ranking models for Web search applications. This is generally because the clickthrough stream is believed to reflect a user's intention with respect to a document.

However, the values of clickthrough features have only very sparse data when using datasets based upon actual search logs. First, for any given query, users only click on a very limited number of documents returned in the results. As a result, the click data is not complete; this is referred to herein as the “incomplete click problem.” Second, for many queries, no click at all is made by users; this is referred to herein as the “missing click” problem.

Such sparseness causes problems when attempting to use clickthrough data for building a document ranking model. With incomplete clicks, the click-related features that can be generated for a document-query pair are incomplete and unreliable. For those pairs without clicks, no clickthrough features can be generated. As a result, the ranking function cannot use and/or rely on clickthrough features to any significant extent.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which sparse clickthrough data (e.g., based on data of a query log) is processed/smoothed into one or more smoothed clickthrough streams. The processing includes determining similar queries for a document with incomplete clickthrough data to provide expanded clickthrough data for that document, and/or by estimating at least one clickthrough feature for a document when that document has missing clickthrough data. In one aspect, determining the similar queries comprises performing random walk clustering and/or session-based query analysis.

The clickthrough streams may be used to provide a ranking model, by extracting clickthrough features from the clickthrough streams, and using the clickthrough features (and other features) to learn the ranking model. The ranking model may then be used in online ranking of documents that are located with respect to a query.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for smoothing clickthrough data that is sparse.

FIG. 2 is a representation of a query-click graph, including a pseudo-click obtained by smoothing clickthrough data

FIG. 3 is a flow diagram showing example steps used in smoothing clickthrough data.

FIG. 4 shows an illustrative example of a computing environment into which various aspects of the present invention may be incorporated.

### DETAILED DESCRIPTION

Various aspects of the technology described herein are generally directed towards resolving the problems with sparse clickthrough data by operating to complete incomplete clicks, and to account for missing clicks. To this end, smoothing techniques are described, including query clustering via random walk on click graphs, to address the incomplete click problem, and a discounting method to estimate the values of the clickthrough features where the document has no click, to account for the missing clicks problem.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in search technology and data processing in general.

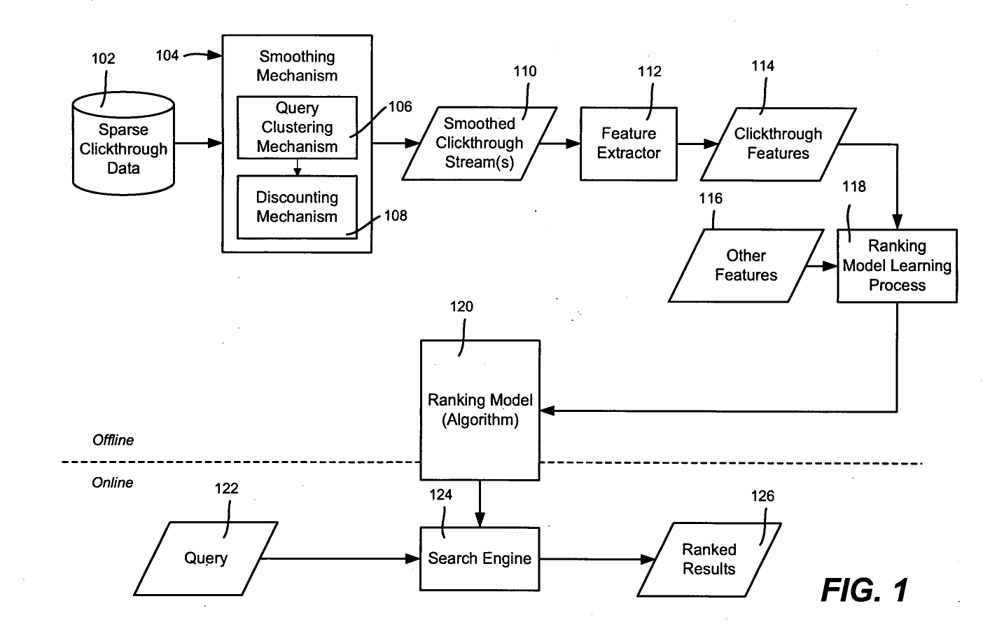

Turning to FIG. 1, there is shown a block diagram representing example components for smoothing clickthrough data 102 that is sparse. The sparseness is likely due to most users only browsing a few top (typically ten) search results, whereby many lower-ranked results, even if they are highly relevant, are rarely browsed or clicked. Further, even if very relevant documents are shown to the user, the user often chooses to click only a few of them, if any.

By way of example, known datasets have a sparseness problem with respect to the clickthrough data; in one set of data, approximately eighty percent of 3.3 million samples (i.e., query-document pairs) do not have any click; that is, the clickthrough features of about 2.64 million samples are assigned a zero value (the missing click problem). For the rest of the data, the lengths of the clickthrough streams have a significantly skewed distribution, with a majority of the samples having very short clickthrough streams (less than five words).

In one implementation, the sparse clickthrough data 102 is based upon a set of query sessions that were extracted from query log files (e.g., one year's worth) of a commercial Web search engine. As used herein, a “query session” contains a query issued by a user and a ranked list of top-N (e.g., ten) links (also referred to as URLs or documents herein) received as results by the same user, whether clicked or not. A query session may be represented by a triplet (q, r, c), representing the query q, the ranking r of documents presented to the user, and the set c of links (documents) on which the user clicked. The dates and times of the clicks also may be recorded.

As described herein, the sparse clickthrough data 102 is processed by a smoothing mechanism 104 comprising a query clustering mechanism 106 and/or a discounting mechanism 108, which smoothes the sparse data 102 into one or more clickthrough streams 110, essentially by completing incomplete clicks via pseudo-clicks and/or accounting for missing clicks via a discounting process. A feature extractor 112 processes these smoothed clickthrough streams 110 into smoothed clickthrough features 114

These smoothed clickthrough features 114, along with other features 116 (e.g., conventional features extracted from query logs/data in a known manner), are used by a known ranking model learning process 118 to provide a ranking model 120. At some later time, in online query processing, when a query 122 is received by a search engine 124, the search engine 124 uses the ranking model 120 to provide ranked results 124.

In general, the queries that resulted in clicks on a document form a description of that document from the users' perspectives. As mentioned above, a Web document can be described by multiple text streams, including a content stream, an anchor stream, and a clickthrough stream. Each line in a clickthrough stream for a URL/document contains a query and a clickthrough score, Score(d, q), which indicates the importance of the query q in describing the document d, (similar to TF-IDF scores). The score can be heuristically derived from raw click information recorded in log files; one suitable function that works reasonably well across known data sets is:

$$Score ( d , q ) = \frac{C ( d , q , click ) + β * C ( d , q , last\_click )}{C ( d , q )} \qquad ( 1 )$$

where C(d,q) is the number of times that d occurs in the query sessions of q in the clickthrough data, C(d,q,click) is the number of times that q resulted in clicks on d, and C(d,q,last_click) is the number of times that d is the temporally last click of q in clickthrough data. Note that intuitively, if a document is the last click of a query, it is more likely that the document is relevant. The weight β is a scaling factor, with a suitable value found to be β=0.2 in one implementation.

In contemporary Web search engines, search results are ranked based on a large number of features extracted from a query-document pair. Because a document is described by multiple text streams, multiple sets of features can be extracted, one from each stream (and the query). Therefore, using clickthrough data for ranking is equivalent to incorporating the clickthrough features, which are extracted from the clickthrough steam, in the ranking (algorithm) model 120. During training, the ranking model 120 can be learned in a known manner, but (instead of as before) is learned using additional features, namely the clickthrough features. At runtime, the search engine 124 fetches the clickthrough features associated with each query-document pair and uses the ranking model 120 for determining each document's relevance ranking with respect to that query.

The following table sets forth some of the clickthrough features that may be used, and describes how their values are computed from the clickthrough scores of the matched queries (to an input query q) in the clickthrough stream (CS):

| | |
|---|---|
| StreamLength_w | number of words in CS |
| StreamLength_q | number of queries in CS |
| WordsFound | Ratio between number of words in q |
| | that occur in CS and number of words |
| | in q |
| CompleteMatches | Sum of the scores of the queries in CS |
| | all of whose words are included in q |
| PerfectMatches | Sum of the scores of the queries in CS |
| | that match q (as a single string) |
| ExactPhrases | Sum of the scores of the queries in CS |
| | that contain q as a substring |
| Occurrences_i | Sum of the scores of the queries in CS |
| | that contain the i-th (i = 1 . . . N) word of q |
| Bigrams | Sum of the scores of the queries in CS |
| | that contain any word-pair in q |
| InorderBigrams | Sum of the scores of the queries in CS |
| | that contain any word-bigram in q |

By way of example, consider a clickthrough stream containing four query-score pairs, as follows:

| Query | Score |
|---|---|
| A B C D | S1 |
| B C A | S2 |
| E A B C D F | S3 |
| B A E | S4 |

Given a four-word input query A B C D, the values of the clickthrough features are as follows:

| | |
|---|---|
| StreamLength_w | 16 |
| StreamLength_q | 4 |
| WordsFound | 1 |
| PerfectMatches | S1 |
| CompleteMatches | S1 + S2 |
| ExactPhrases | S1 + S3 |
| Occurrences_1 | S1 + S2 + S3 + S4 |
| . . . | . . . |

Any ranking model can be used to incorporate a set of features, such as RankSVM, RankNet and LambdaRank; LambdaRank is used herein. With LambdaRank, training data is a set of input/output pairs (x, y); x is a feature vector extracted from a query-document pair, where the document is represented by multiple text streams. Approximately 400 features are used, including dynamic ranking features such as term frequency and BM25 value, and static features similar to PageRank. The y value is a human-judged relevance score, 0 to 4, with 4 as the most relevant.

LambdaRank is a neural net ranker that maps a feature vector x to a real value y that indicates the relevance of the document given the query (relevance score). For example, LambdaRank maps x to y with a learned weight vector w such that y=w·x. Typically, w is optimized with respect to a cost function using numerical methods if the cost function is smooth and its gradient with respect to w can be computed. In order for the ranking model to achieve the best performance in document retrieval, the cost function used during training should be the same as, or as close as possible to, the measure used to assess the final quality of the system.

In web searching, Normalized Discounted Cumulative Gain (NDCG) is widely used as quality measure. For a query q, NDCG is computed as:

$${𝒩}_{i} = {N}_{i} {\sum }_{j = 1}^{L} \frac{{2}^{r ( j )} - 1}{log ( 1 + j )} , \qquad ( 2 )$$

where r(j) is the relevance level of the j-th document, and where the normalization constant Nᵢ is chosen so that a perfect ordering would result in Nᵢ=1. Here L is the ranking truncation level at which NDCG is computed. The Nᵢ are then averaged over a query set. However, NDCG, if used as a cost function, is either flat or discontinuous everywhere, and thus presents particular challenges to most optimization approaches that require the computation of the gradient of the cost function.

LambdaRank solves the problem by using an implicit cost function whose gradients are specified by rules. These rules are called λ-functions.

Turning to smoothing, to deal with the incomplete click problem, the query clustering mechanism 106 is used, which is based upon a random walk technique. In general, clustering ensures that a sufficient number of samples are available to make probability calculations reliable; such clustering can be used to smooth clickthrough features. For example, the value of the StreamLength feature (or features) indicates the popularity of a document, because popular documents receive more clicks. However, a document d₁, with a StreamLength of two is not necessarily twice as popular as a document d₂, with a StreamLength of one, because there is not enough data to meaningfully support such a conclusion.

However, by expanding the stream with “similar” queries that are likely to result in the same document being clicked, but are not recorded in the log data for some reason (e.g., the log data is not complete or biased by ranking results of a search engine), more data becomes available. With such expanded data, if the StreamLengths of the expanded streams of d₁ and d₂ are 200 and 100, respectively, there is greater confidence that d₁ is more popular than d₂.

Thus, for a given document, a set of similar queries that will likely have resulted in clicks on the document need to be determined. To this end, co-clicks are exploited, comprising queries for which users have clicked on the same documents; such queries can be considered similar. By way of a simplified example, if document d₃ was clicked via query q₂, and both query q₁ and query q₂ have clicked on another document d₁ relatively many times, then it is likely that query q₁ and query q₂ are similar; q₁ can thus be a pseudo-click candidate for expanding the clickthrough stream for the document d₃.

By grouping URLs/documents into clusters, such similar queries may be determined. However, instead of defining a static function of similarity according to the number of co-clicks, a random walk technique is used to dynamically derive the static function of similarity.

To determine similar queries, a click graph, which is a bipartite-graph representation of clickthrough data is constructed; to this end {qᵢ}ᵢ₌₁^{m} is used to represent a set of query nodes, and {dⱼ}ⱼ₌₁ⁿ to represent a set of document nodes. An m×n matrix W is defined in which element Wᵢⱼ represents the click count associated with (qᵢ, dⱼ). This matrix can be normalized to be a query-to-document transition matrix, denoted by A, where Aᵢⱼ=p⁽¹⁾(dⱼ|qᵢ) is the probability that qᵢ transitions to dⱼ in one step. Similarly, the transpose of W is normalized to be a document-to-query transition matrix, denoted by B, where B_{j,i}=p⁽¹⁾(qᵢ|dⱼ). Using A and B computes the probability of transitioning from any node to any other node in k steps. Note that there are various ways of evaluating query similarities based on a click graph, e.g. using hitting time. One measure is the probability that one query transitions to another in two steps; the corresponding probability matrix is given by AB.

Based on this measure, for each query q in the original clickthrough stream, a number (e.g., eight) of most similar, previously absent queries to the expanded stream are selected. To be considered sufficiently similar to be added, a query q′ needs to satisfy p⁽²⁾(q′|q)>α, (where α=0.01 in one implementation). Alternatively, queries may be considered similar using the inverse of the query to the candidate query, that is, if p⁽²⁾(q|q′)>α.

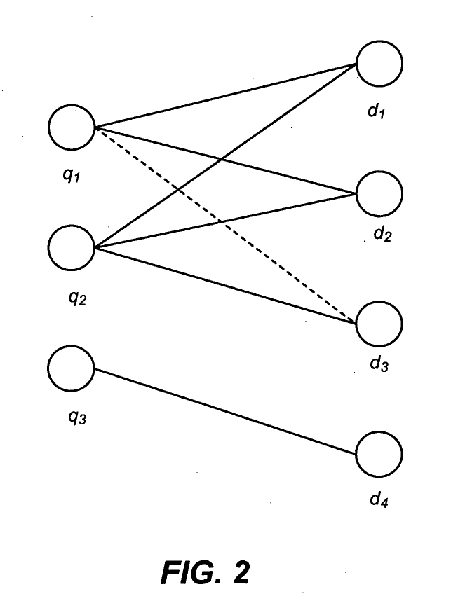

FIG. 2 shows such a concept. Before expansion, document d₃ has a clickthrough stream of only query q₂ (as indicated by the solid line); after expansion, the clickthrough stream is augmented with query q₁ (as indicated by the dashed line) which has a similar click pattern as q₂.

Note that the actual and expanded (psuedo) clickthrough stream may be used as one concatenated stream for extracting the set of clickthrough features. Alternatively, the actual clicks may be used as one clickthrough stream for one set of features, and the pseudo-clicks may be used as another clickthrough stream for another set of features; in other words, the expanded stream is used in parallel with the original stream for feature extraction. These features/feature sets may be weighted as desired.

Another way to complete incomplete clicks is based upon user session data, where a session is some length of time (e.g., five minutes). In general, the queries of the same user within a session tend to be somewhat related. For example, if a user submits a query, the user often reformulates the query and submits the reformulated query. Although for any given session whether a series of queries is related or not cannot be determined with certainty, when aggregated over many millions of sessions of various users, statistical patterns emerge that indicate related queries. Thus, a clickthrough stream may be expanded by session-based analysis to determine related queries.

Turning to another aspect, to resolve the missing click problem, the discounting mechanism 108 is used, which is somewhat based on the known Good-Turing estimator. Let N be the size of a sample text, and nᵣ be the number of words which occurred in the text exactly r times, so that

N=Σᵣrnᵣ. (3)

Good-Turing's estimate P_{GT} for a probability of a word that occurred in the sample r times is

$${P}_{GT} = \frac{{r}^{*}}{N} \qquad ( 4 )$$

where

$${r}^{*} = ( r + 1 ) \frac{{n}_{r + 1}}{{n}_{r}} . \qquad ( 5 )$$

The procedure of replacing an empirical count r with an adjusted count r* is called discounting, and a ratio r*/r is a discount coefficient. When r* is defined as Equation (5), Good-Turing discounting exists. Note that when applying Good-Turing discounting to estimating n-gram language model probabilities, high values of counts may not be discounted, as they may be considered reliable. That is, for r>k (typically k=5), r*=r.

Note that (r+1)nᵣ₊₁ is the total count of words with frequency r+1, which is denoted herein by Cᵣ₊₁. Then equation (5) can be rewritten as:

$${r}^{*} = \frac{{C}_{r + 1}}{{n}_{r}} . \qquad ( 6 )$$

However, replacing a raw click count (such as C(d,q, last) and C(d,q, click_last) in Equation (1)) with its adjusted count according to Equation (5) does not work. More particularly, while the clickthrough scores are derived from the raw click counts, the values of the clickthrough features are computed based on not only the clickthrough scores but also the specific words in the clickthrough stream. If the raw click counts are adjusted, this expands the clickthrough stream of a document to an infinitely large set by assigning a non-zero score to any possible query that does not have a click on the document. This makes most of the features whose values are based on word or n-gram matching meaningless.

Therefore, instead of discounting raw click counts as in the Good-Turing estimator, a heuristic method based upon the Good-Turing estimator may be used to directly discount the clickthrough feature values. Let fᵣ be the value of a clickthrough feature in a training sample whose clickthrough stream is of length r, where the length is measured in terms of the number of the queries that have click(s) on the document (i.e., StreamLength_q). Assume that the feature values fᵣ, for r>0, have been smoothed, such as by using the random walk based method described above. To address the missing click problem, f₀* is estimated; f₀=0 for the raw clickthrough features.

Let f₁ᵢ, i=1 . . . n₁, be the value of a feature in the i-th training sample whose clickthrough stream is of length one. As a consequence, the sum of f₁ᵢ over the training samples is Σᵢ₌₁ⁿ^{₁}f_{1,i}. Then, similar to Equation (6), f₀* is computed as:

$${f}_{0}^{*} = \frac{{\sum }_{i = 1}^{{n}_{1}} {f}_{1 , i}}{{n}_{0}} . \qquad ( 7 )$$

where n₀ is the number of the samples whose clickthrough streams are empty.

Since n₀>>n₁, then f′₁>>f₀*>f₀=0. That is, for each type of clickthrough features, Equation (7) assigns a very small non-zero constant if the feature is in a training sample whose clickthrough stream is empty (i.e., the raw feature value is zero). This will prevent the ranker from considering unclicked documents to be categorically different from clicked ones. As a consequence, the ranker can rely more on the smoothed features.

By way of an example, assume that given a query q, two documents, d₁ and d₂, have been retrieved based on their content streams. Now, the process may adjust their ranking based on their clickthrough streams (e.g., using their clickthrough features such as PerfectMatches). Assume that d₁ has many clicks and d₂ has no click because d₂ is a new URL and there is not enough click data collected yet for d₂. If PerfectMatches=0 for both d₁ and d₂, intuitively d₂ should be ranked higher because the fact that q does not match any queries, collected previously, which have clicks on d₂, seems to provide a piece of evidence that d₁ might be irrelevant, whereas there is no evidence about the relevance or irrelevance of d₂. Using the discounting smoothing method of Equation (7), d₂ is ranked higher, in agreement with this intuition.

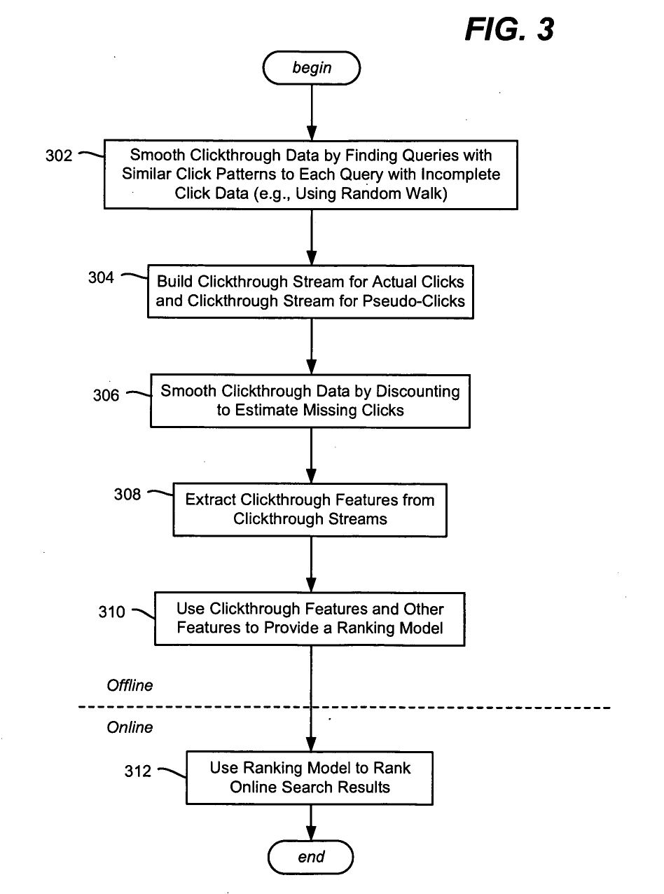

FIG. 3 summarizes example steps, beginning at step 302 which represents smoothing the clickthrough data by finding queries with similar click patterns for each query with incomplete click data (e.g., using random walk). Step 304 represents building a clickthrough stream for the actual clicks and the clickthrough stream for the pseudo-clicks. Step 306 represents smoothing the clickthrough data by discounting to estimate missing clicks.

At step 308, the clickthrough features are extracted from the actual clickthrough stream and the pseudo clickthrough stream. These features are used along with other features to provide a ranking model (step 310), which is then later used to rank online search results.

### Exemplary Operating Environment

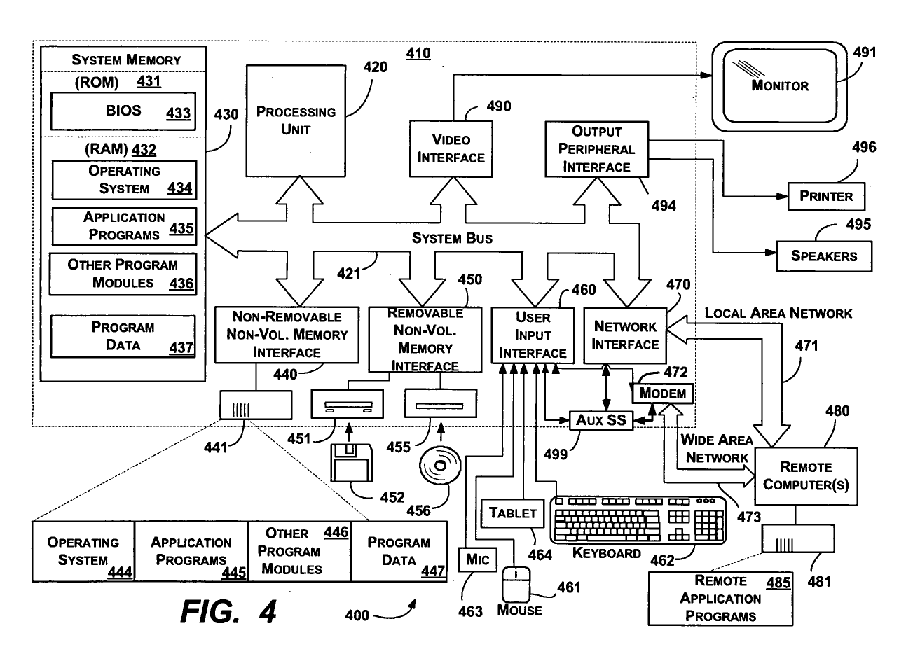

FIG. 4 illustrates an example of a suitable computing and networking environment 400 into which the examples and implementations of any of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component 474 such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, smoothing sparse clickthrough data into one or more smoothed clickthrough streams, extracting clickthrough features from the smoothed clickthrough streams, and using the clickthrough features to provide a ranking model.

2. The method of claim 1 further comprising, using the ranking model in online query processing to rank results corresponding to a query.

3. The method of claim 1 wherein smoothing the sparse clickthrough data comprises performing clustering based on similar queries.

4. The method of claim 3 further comprising, performing a random walk to determine the similar queries.

5. The method of claim 1 wherein smoothing the sparse clickthrough data comprises determining similar queries based upon user sessions.

6. The method of claim 1 wherein smoothing the sparse clickthrough data into one or more smoothed clickthrough streams comprising providing an actual clickthrough stream based upon actual clickthrough data and providing a pseudo-clickthrough stream based upon clickthrough data determined from similar queries to a query having incomplete clickthrough data.

7. The method of claim 1 wherein smoothing the sparse clickthrough data comprises performing a discounting process to estimate at least one clickthrough feature for a document when the document has missing clickthrough data.

8. In a computing environment, a system comprising, a smoothing mechanism that processes sparse clickthrough data into one or more smoothed clickthrough streams, a feature extraction mechanism that extracts clickthrough features from the smoothed clickthrough streams, and a ranking model learning mechanism that uses the clickthrough features and other features to provide a ranking model.

9. The system of claim 8 further comprising, a search engine that uses the ranking model in online query processing to rank results corresponding to a query.

10. The system of claim 8 wherein the smoothing mechanism includes a query clustering mechanism that determines similar queries to a query having incomplete clickthrough data.

11. The system of claim 10 wherein the query clustering mechanism performs a random walk to determine the similar queries.

12. The system of claim 8 wherein the smoothing mechanism determines the similar queries based upon user sessions.

13. The system of claim 8 wherein the smoothed clickthrough streams comprise an actual clickthrough stream based upon actual clickthrough data and an expanded clickthrough stream based upon clickthrough data corresponding to the similar queries as determined by the smoothing mechanism.

14. The system of claim 8 wherein the smoothing mechanism includes a discounting mechanism that estimates at least one clickthrough feature for a document when the document has missing clickthrough data.

15. The system of claim 8 wherein the clickthrough features include a number of words in the clickthrough stream, a number of queries in the clickthrough stream, a ratio between a number of words in the query that occur in the clickthrough stream and a number of words in the query, a sum of the scores of the queries in the clickthrough stream whose words are included in the query, a sum of the scores of the queries in the clickthrough stream that match the query, a sum of the scores of the queries in the clickthrough stream that contain the query as a substring, a sum of the scores of the queries in the clickthrough stream that contain a given word of the query, a sum of the scores of the queries in the clickthrough stream that contain any word-pair in the query, or a sum of the scores of the queries in the clickthrough stream that contain any word-bigram in the query, or any combination of a number of words in the clickthrough stream, a number of queries in the clickthrough stream, a ratio between a number of words in the query that occur in the clickthrough stream and a number of words in the query, a sum of the scores of the queries in the clickthrough stream whose words are included in the query, a sum of the scores of the queries in the clickthrough stream that match the query, a sum of the scores of the queries in the clickthrough stream that contain the query as a substring, a sum of the scores of the queries in the clickthrough stream that contain a given word of the query, a sum of the scores of the queries in the clickthrough stream that contain any word-pair in the query, or a sum of the scores of the queries in the clickthrough stream that contain any word-bigram in the query.

16. The system of claim 8 wherein the sparse clickthrough data comprises query session data, including query data, ranking data and click data for each query of a set of queries.

17. One or more computer-readable media having computer-executable instructions, which when executed perform steps, comprising, processing clickthrough data into one or more clickthrough streams, including determining similar queries for a document with incomplete clickthrough data to provide expanded clickthrough data for that document, and estimating at least one clickthrough feature for a document when that document has missing clickthrough data.

18. The one or more computer-readable media of claim 17 wherein determining the similar queries comprises performing random walk clustering or session-based query analysis, or both random walk clustering and session-based query analysis.

19. The one or more computer-readable media of claim 17 having further computer-executable instructions comprising, extracting clickthrough features from the clickthrough streams and using the clickthrough features to provide a ranking model

20. The one or more computer-readable media of claim 19 having further computer-executable instructions comprising, using the ranking model in online ranking of documents that are located with respect to a query.
